(19) United States
(12) Patent Application Publication
(10) Pub. No.: US 2017/0063948 A1
(43) Pub. Date: Mar. 2, 2017

(54) STATE-BASED SUBSCRIPTION AUTHORIZATION SYSTEM WITH FALL-BACK

(71) Applicant: Vuclip, Milpitas, CA (US)

(72) Inventors: Shishir Shroff, Mountain View, CA (US); Bo Shen, Fremont, CA (US)

(21) Appl. No.: 14/842,585

(22) Filed: Sep. 1, 2015

(51) Int. Cl. H04L 29/06

(52) U.S. Cl. CPC H04L 65/4092; H04L 63/10

(57) ABSTRACT

A centralized authorization system authorizes content access requests for electronic content distributed over one or more networks in association with multiple third-party entities. Access to content is controlled by subscriptions. Subscriptions are requested by clients and granted if eligibility criteria are met. User accounts are assigned to different subscription states reflecting the states of their subscriptions. Subscription states may include, for example, an activated state, a deactivated state, a suspended state, a grace state, and/or a parking state. Different access rules are assigned to different states. A content authorization component authorizes content access requests based on applying these rules to the appropriate assigned states for the user accounts. The system includes a configuration interface by which third parties may configure specific access rules and other options that apply for their user accounts or subscriptions. Subscription retry and fallback logic may be provided.

### TECHNICAL FIELD

Embodiments relate generally to electronic content access, and, more specifically, to techniques for authorizing access to content in complex distribution systems involving content distributed on behalf of multiple entities.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The distribution of content, such as text, videos, music, or other media, over a communication network entails delivering electronic files and/or data streams from servers or other data sources to client devices (hereinafter “clients”). Example communication networks include wide-area networks such as the Internet, cellular communication networks, and so forth. Example clients include mobile phones, tablets, gaming consoles, set-top boxes, or other multi-media devices.

For various reasons, a client's access to the content is often authorized prior to the client obtaining or presenting the content. For instance, when requesting content, the client may be directed through a portal and/or gateway that ensures that the client owns a license to the content or has a subscription that permits the client access to the content. If the client is authorized to access the content, the client may then be redirected to a source from which the client may download or stream the content. As another alternative, a client may be configured to receive authorization from a server prior to presenting content the client has already downloaded.

Some content distribution systems may be configured to provide content on behalf of or in association with various third-party entities in addition to or instead of direct distribution to clients. For instance, a content distributor may come to an agreement with a network service provider, such as a mobile network operator, to provide content to clients that access the network through the provider's equipment or a captive portal. Or the content distributor may come to an agreement with a web portal to provide clients that visit the web portal with access to content under the web portal's brand.

To the clients, such access may appear, at least on some level, to be provided and/or managed by the third-party entity instead of the content distributor. For instance, the application or web portal via which the client obtains access to the content may take an appearance that is consistent with the third-party entity rather than the content distributor, or may have a web address that belongs to the provider. As another example, billing for access to the content may occur using the third-party entity's accounts or billing services. As yet another example, the accessible content, prices, and/or types of subscriptions may vary depending on the third-party entity.

Typically, the computing infrastructures that implement the services provided under such arrangements between content distributors and third-party entities, particularly with respect to subscription management and authorization, are formed on an ad-hoc basis. The infrastructure deployed for a given third-party may sometimes have little re-usability and/or consistency with that deployed for another third-party. Management and maintenance of such ad hoc computing infrastructure can be expensive and time-consuming. The separate ad hoc infrastructures may furthermore require separately maintained computer systems and/or processes.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative view of various aspects of an example system in which the techniques described herein may be practiced;

FIG. 2 illustrates an example flow for management of a subscription state;

FIG. 3 illustrates an example content distribution system that supports bifurcated subscription management;

FIG. 4 illustrates an example architecture for supporting supports multiple carriers using a centralized content distribution system;

FIG. 5 illustrates an example state machine conforming to a template for carrier-managed subscriptions;

FIG. 6 illustrates an example state machine conforming to a template for asynchronous centrally-managed subscriptions;

FIG. 7 illustrates an example state machine conforming to a template for synchronous centrally-managed subscriptions;

FIG. 8 illustrates an example state machine conforming to a template for external billing options; and

FIG. 9 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

1.0. General Overview

2.0. Structural Overview
2.1. Carriers and Other Third-Parties
2.2. Clients
2.3. User Accounts
2.4. Subscriptions
2.5. Subscription Eligibility Verification
2.6. Renewals
2.7. Fallback Subscriptions
2.8. Retry Logic
2.9. Subscription States and State Machines
2.10. Events and State Transitions
2.11. Types of State Machines
2.12. Request Authorization and Access Rules
2.13. Configuration Interface
2.14. Miscellaneous

3.0. Functional Overview

4.0. Implementation Examples
4.1. Content Distribution System Supporting Bifurcated Subscription Management
4.2. Example Platform Architecture
4.3. Example State Machines
4.4. Example APIs

5.0. Example Embodiments

6.0. Implementation Mechanism—Hardware Overview

7.0. Extensions and Alternatives

### 1.0. GENERAL OVERVIEW

Approaches, techniques, and mechanisms are disclosed for centralized authorization of content access requests for electronic content distributed over one or more networks in association with multiple third-party entities. According to one embodiment, access to content is controlled by subscriptions, which may be requested by clients and granted if certain subscription eligibility criteria are met. User accounts associated with the clients are assigned to different subscription states reflecting the states of their subscriptions. The subscription states may include, for example, an activated state, a deactivated state, a suspended state, a grace state, and/or a parking state. Different access rules are assigned to different states, and a content authorization component is configured to authorize content access requests based on applying these rules to the appropriate assigned states for the user accounts.

The system includes a configuration interface by which third parties may configure specific access rules that apply for their user accounts or subscriptions. For instance, one third-party may configure an access rule that permits access to only certain types of content when in a grace state, while another third-party may configure an access rule that permits access to all content while in a grace state.

In an embodiment, the system comprises various state machine components that manage state machines for the user accounts and their subscriptions. Each state machine transitions a user account between assigned subscription states based on state transitions between the states. State transitions are triggered in response to various events. These events may include subscription events such as an initial subscription, a subscription failure, a subscription renewal, a subscription renewal failure, a deactivation request, and so forth. These events may also include time-based events, such as the passage of a designated amount of time. The state transitions may themselves be configurable through the configuration interface.

According to an embodiment, a subscription management system uses various techniques to optimize access to content even when the eligibility criteria for a subscription, such as successful billing of a prescribed fee, fails. For instance, the system may utilize retry logic that continues to attempt to verify whether the eligibility criteria can be met at various intervals over a period of time. The retry logic may be optimized to make retry attempts at times more likely to lead to a successful verification of subscription criteria, so as to reduce resource utilization. As another example, the system may utilize fallback logic whereby, if the eligibility criteria for a higher-level or longer subscription cannot be met, eligibility criteria for lower-level or shorter subscriptions are tested until some subscription can be activated.

In other aspects, the invention encompasses computer apparatuses and computer-readable media configured to carry out the foregoing techniques.

### 2.0. STRUCTURAL OVERVIEW

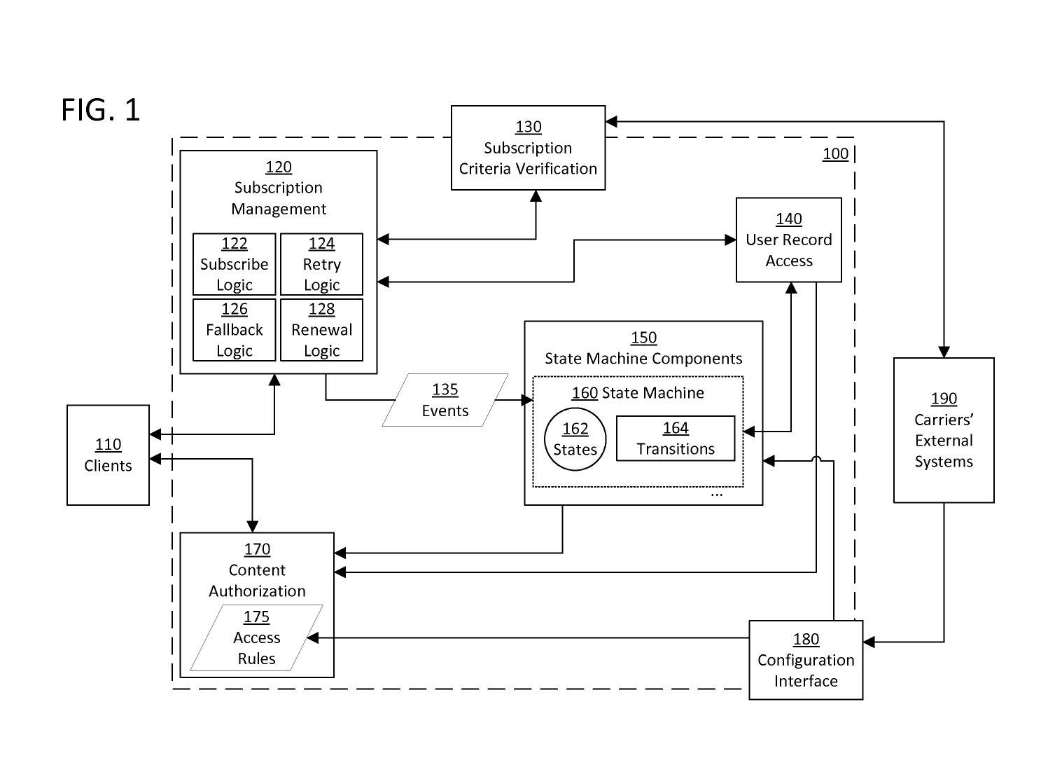

FIG. 1 is an illustrative view of various aspects of an example system 100 in which the techniques described herein may be practiced, according to an embodiment. System 100 comprises one or more computing devices. These one or more computing devices comprise any combination of hardware and software configured to implement the various logical components described herein, including components 120-180. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

2.1. Carriers and Other Third-Parties

System 100 is a content authorization system that provides content authorization services to clients 110 for content distributed by one or more content distributors in association with or on behalf of multiple third-party entities. For convenience, these third-party entities are hereinafter referred to as “carriers,” but may in fact include network service providers, web portals, or any other entity on behalf of whom content may be distributed, as well as payment system providers, banking service providers, credit card service providers, and so forth. In an embodiment, each of these carriers has an external system 190 of computing devices that operate servers and/or other networking equipment through which corresponding sets of clients 110 obtain access to content from the one or more content distributors. In an embodiment, external system 190 may also or instead provide services by which clients 110 engage in certain prerequisite activities for gaining access to content, such as engaging in or scheduling financial transactions, or providing or viewing certain information. System 100 may be operated by one of the content distributors, one of the carriers, or any other suitable entity.

2.2. Clients

Clients 110 are multimedia devices configured to download and/or receive data streams of content over one or more networks coupled to system 100. For simplification, the actual content and download/streaming components, which may lie inside or outside of system 100, are not depicted, as any suitable techniques may be used by a client 110 to receive content. Rather, the depicted portions of system 100 are configured to authorize requests from clients 110 to access content. In an embodiment, system 100 is configured to authorize requests before the clients 110 retrieve the content, in which case system 100 redirects the clients to the appropriate source for the content upon authorization. In an embodiment, system 100 is configured to also or instead authorize requests before the clients 110 present contents that have already been received by the clients 110, in which case the clients 110 are configured to wait for an authorization acknowledgement message prior to presenting the content.

2.3. User Accounts

System 100 comprises one or more user record access components 140. A user record access component 140 is configured to locate, read, and write user account records, at the request of any other components of system 100. The user account records are data structures stored in one or more data repositories, such as databases or file systems. Each user account record describes various aspects of a different user account, such as a user name, password, one or more assigned subscription states corresponding to one or more different sets of contents, billing information, tracking data, demographic information, and so forth.

A user account record may become associated with a client 110 through log-in processes. This association may be maintained through the use of saved authorization data, such as in cookies returned from the client or session information stored at system 100 in association with an identifier of the client 110. Depending on the embodiment, a client 110 may be associated with multiple user account records, in which case a “currently” associated user account record is determined based on information included in the client 110′s interactions with the system 100. Depending on the embodiment, a user account record may be associated with multiple clients 110.

In an embodiment, there may be distinct subsets of the user account records, each corresponding to a different carrier. For instance, there may a separate data repository of user account records for each carrier. Or, there may be mapping data that associates each user account record with one or more carriers for which subscription states have been assigned to the user account records.

Some or all of the one or more data repositories that store user account records may be part of user record access component 140, and/or may be located at least partially outside of user record access component 140. In an embodiment, at least one data repository that stores user account records is located outside of system 100—for instance, within a carrier external system 190. In another embodiment, copies of certain user records may be synchronized between system 100 and certain external systems 190. Moreover, the user account record need not be represented by a single physical data structure, but rather may comprise various related structures stored in multiple tables, table records, files, or even data repositories.

2.4. Subscriptions

System 100 further comprises one or more subscription management components 120. A subscription management component 120 is configured to generate, manage, renew, cancel, and/or change subscriptions. A subscription management component 120 may implement, for example, subscribe logic 122 configured to receive and process requests from clients 110 for new subscriptions. Such requests may be received, for instance, in response to clients 110 interfacing with a portal web site or application for a content distributor or external system 190. The portal web site or application may redirect the clients 110 to a server of system 100 that implements the subscribe logic 122. Such requests may also or instead be received from carrier systems 190 or content distribution systems on behalf of clients 110.

The subscribe logic 122 may be configured to collect data from a client 110 and/or external system 190 to create a new user account record for the client 110. Or, a suitable user account record may already exist on account of synchronization processes between a system 190 and system 100. Or, a suitable user account record may already exist on account of the client 110 previously interacting with system 100 for other subscriptions or purposes. Subscriptions are generated by storing data representing the subscription, such as subscription state data or other data, in association with the subscribed user account record.

The subscribe logic 122 may further be configured to confirm that a user associated with a client 110 does in fact wish to make a new subscription. For instance, the subscribe logic may implement a consent gateway configured to send information about a subscription for a client 110 to display, such as subscription eligibility criteria, content sets corresponding to the subscription, a subscription length, renewal terms, etc. The subscribe logic 122 may wait for an acknowledgment message from the client 110 indicating that the associated user does wish to proceed with the subscription.

2.5. Subscription Eligibility Verification

Subscription management component 120 is coupled to one or more subscription eligibility criteria verification components 130. If a user does in fact wish to make a new subscription, the subscribe logic 122 interacts with subscription eligibility criteria verification component 130 to initiate various processes to ensure that various eligibility criteria are met for the subscription. Subscription management component 120 may store or have access to a list of possible subscription types for the carriers, along with a mapping of subscription eligibility criteria to the subscription types. The subscription eligibility criteria may include, for instance, required user demographic characteristic(s), approval of the subscription by the user and/or another party, successful payment of a fee associated with the subscription, required user client device characteristic(s), or any other suitable criteria. Once the appropriate criteria are identified, subscription management component 120 may send information indicating the appropriate subscription eligibility criteria to the responsible subscription eligibility criteria verification component(s) 130.

A subscription eligibility criteria verification component 130 may, for instance, be a billing service component that the subscription management component 120 instructs to debit, transfer, or otherwise bill a specified amount from a financial account identified by client 110 or associated with a corresponding user record. An identifier for the financial account may have been specified by the client 110 when requesting access to the content, or when sending a consent acknowledgement message. Or the financial account identifier may already have been stored in association with the user account record as a result of previous interactions between the client 110 and system 100 or an external system 190. In an embodiment, the billing service component is coupled to external system 190 to interface therewith to execute billing requests. In an embodiment, component 130 is actually an interface to external system 190 for instructing external system 190 to execute a billing request.

For instance, system 100 may include a number of billing components that interact directly with banks, credit card companies, or other payment services. The subscribe logic 122 is configured to identify one of the billing components that is capable of billing the identified financial account, and send the identified billing component an identifier for the financial account and an amount to bill. In some embodiments, one or more of the billing service components may be external to system 100—for instance, certain external systems 190 may include application programming interfaces (APIs) for initiating carrier-based billing processes that debit carrier financial accounts associated with corresponding user account records. In any event, in embodiments that include a billing service component, subscribe logic 122 waits for a confirmation message verifying that the billing component successfully billed the identified financial account before activating a new subscription.

Of course, many other types of subscription eligibility criteria verification components 130 may exist. These components 130 may verify eligibility criteria using any suitable mechanisms, such as querying user account records in system 100 or elsewhere to verify relevant information about a user, interfacing directly with a client 110 to gather information, and so forth. In view of the foregoing, it should be clear that there may be different subscription eligibility criteria verification components 130 for different carriers, eligibility criteria types, user preferences, and so forth.

2.6. Renewals

Subscription management component 120 further comprises renewal logic 128. Renewal logic 128 is configured to renew the subscriptions generated by subscribe logic 122 at various time periods, depending on the embodiment. To renew a subscription, the renewal logic 128 is configured to interact with the one or more of the subscription eligibility criteria verification components 130 to again initiate processes to ensure that various eligibility criteria are met for the subscription, as with the subscribe logic 122. For instance, if a component 130 is a billing service component, the renewal logic 128 may instruct the component 130 to again bill an amount associated with the subscription to a financial account associated with the user account record. If the one or more subscription eligibility criteria verification components 130 acknowledge that the eligibility criteria have again been met, the subscription is renewed, and the renewal logic 128 updates the corresponding subscription data associated with the user account record to reflect the new subscription expiration date or any other changes to the subscription.

Generally, the renewal logic 128 is executed for a particular subscription at a time intended to ensure that the subscription will always be active when needed for the corresponding user account, so long as the subscription eligibility criteria continue to be met. This time is typically related to or even a function of the length of the subscription. For instance, the renewal time may be a pre-determined time that is scheduled based on the length of the subscription, a time that renewal logic 128 detects that the subscription is expired or within a threshold amount of time of expiring, the next time that access is requested for a corresponding user account after the subscription has expired, or any other suitable time.

2.7. Fallback Subscriptions

In an embodiment, subscription management component 120 further comprises optional fallback logic 126. Fallback logic 126 is configured to attempt to subscribe user account records to lesser or alternative subscriptions when eligibility criteria for the requested subscription is not met. For instance, if a client 110 requests a premium-level subscription, but does not have sufficient funds available or is otherwise ineligible for the premium-level subscription, various lower-level subscriptions may be attempted in succession until a subscription criteria eligibility verification component 130 indicates that eligibility criteria corresponding to one of the fallback levels has been met, or until there are no remaining fallback levels.

As a more specific example, a client 110 may initially request a default subscription level for $9.99. The subscribe logic 122 or renewal logic 128 may instruct a billing component 130 for the carrier of client 110 to attempt to bill the $9.99. If the billing attempt fails, then the subscription fails. However, with the fallback logic 126, subscription management component 120 may identify a mid-level subscription that is available for $4.99, and instruct a billing component 130 for the carrier of client 110 to attempt to bill the $4.99. If that fails, the subscription management component 120 may identify a lower-level subscription for $1.99, and instruct a billing component 130 for the carrier of client 110 to attempt to bill the $1.99. If that fails, the subscription management component 120 may identify a one-time trial subscription that is free, and instruct a subscription criteria eligibility verification component 130 to check to see if the client 110 is still eligible for the trial subscription. If that fails, then the client 110 does not receive a subscription.

Fallback attempts may be attempted for both failed initial subscriptions and failed renewals. Thus, for instance, a user account having a subscription A may be renewed to a lower-level subscription B if the renewal of subscription A fails. The fact that consent was granted for subscription A may nonetheless remain recorded in the user account record, and the user account may again be renewed to subscription A if eligible at a subsequent time. In some embodiments, subscription management 120 may provide various web-based or other interfaces that allow a user to request that their subscription be upgraded at any time (e.g. restoring their service level to a higher subscription once the user knows that sufficient funds are available and/or that other eligibility criteria can be met).

The exact set of subscriptions to fall back on may be predefined, or configurable for different client types, carriers, time periods, or any other context. The subscriptions in the set may vary from each other both in subscription eligibility criteria and provided benefits. Generally, but not necessarily, the first attempted subscription will be a higher-level subscription and each subsequently attempted subscription will be an increasingly “lower-level” subscription in some aspect. Lower-level subscriptions may, for instance, provide access for smaller periods of times than higher-level subscriptions, provide access to smaller sets of contents than higher-level subscriptions, provide access to lesser quality content than higher-level subscriptions, and so forth.

In an embodiment, the fallback scheme may be a function of constraints on specific monetary amounts that can be billed to a financial account. For instance, a carrier may only permit debits from the carrier's billing accounts on the order of $1.00, $0.50, and $0.25. The default subscription offered to user account records that pertain to that carrier may begin at one week in length for $1.00, with the fallback subscriptions approximately pro-rated to three days in length and one day in length in proportion with the $0.50 billing level and the $0.25 billing level. Hence, if a user attempts to subscribe for the default subscription when the user only has $0.40 available, the fallback logic 126 would eventually cause subscription management component 120 to generate a one-day subscription, with the user account record being billed only $0.25. Another carrier may impose different billing constraints, and different subscription levels having correspondingly different lengths would be offered for user account records that pertain to that carrier.

In an embodiment, a user may receive notifications when his or her user account record is enrolled in a fallback subscription rather than the requested subscription. The notification may include information about the differences between the fallback subscription and the requested subscription. The notification may optionally include instructions to the user for taking certain actions to restore the user account record to the originally requested subscription. In other embodiments, no notification is given.

2.8. Retry Logic

In an embodiment, subscription management component 120 further comprises optional retry logic 124. The retry logic 124 is configured to repeatedly initiate attempts by the appropriate one or more subscription eligibility criteria verification components 130 to verify the subscription eligibility criteria of a user account record for which consent to subscribe had been obtained, but the verification has not yet been successful. For instance, if the amount required for a subscription was not previously successfully billed by a subscription eligibility criteria verification component 130, the retry logic 124 may instruct the subscription eligibility criteria verification component 130 to attempt to bill the requisite amount at additional times until the subscription eligibility criteria verification component 130 reports that a successful charge. Retry attempts may be made for both failed initial subscriptions and failed renewals.

In some embodiments, retry logic 124 is configured to retry any time a failure message is received from a subscription management component 120, or at regular intervals until confirmation of success is received. In other embodiments, more sophisticated retry logic 124 is configured to identify optimal times to attempt to verify the relevant subscription eligibility criteria. For instance, a certain financial account corresponding to a certain user account record may be more likely to have funds available at certain times of the day and/or certain days of the week (e.g. before lunch, in the evening, on days that are commonly considered paydays, etc.). Since retry attempts may waste system resources and possibly even cost system 100 a non-trivial amount in fees for billing requests or other services, retry logic 124 is configured only to retry the verification processes at the identified optimal times. In an embodiment, the optimal times may even vary from user account record to user account record, as a function of demographic information associated with the records, histories of past verification failures or successes, or any other suitable factor(s).

In some embodiments, retry logic 124 co-exists with fallback logic 126. For instance, for each “retry” attempted by retry logic 124, the fallback logic 126 may be performed. Hence, a user may not qualify for any subscription on an initial attempt to activate a subscription, but after a couple of retries by retry logic 124, suddenly become eligible for a lower-level subscription on account of a fall back attempt by fallback logic 126. However, in other embodiments, system 100 may only have one of retry logic 124 or fallback logic 126. In an embodiment, retry logic 124 may attempt to retry a higher-level subscription even when fallback logic 126 successfully establishes a lower-level subscription. However, this need not be the case in other embodiments.

In an embodiment, a user may receive notifications as part of the retry logic, prompting the user to add funds to the user's account or complete other subscription eligibility criteria. The notification may optionally identify a next time that the subscription will be attempted, or a time by which the eligibility criteria must be met for the user account record to remain in a subscription state that allows access to certain content. The notification may be received as soon as verification fails, or sent only when the user attempts to access content associated with the subscription. In other embodiments, no notification is needed.

2.9. Subscription States and State Machines

According to an embodiment, subscription management component 120 is further configured to generate event records 135 that are sent to or otherwise accessed by state machine components 150 in system 100. The state machine components 150 are a plurality of components configured to instantiate, manage, and execute state machines 160. Each state machine 160 is one or more computer processes that implement program logic for tracking the subscription state of a subscription for a user account record and transitioning to other subscription states based on events such as events 135. There may be a separate state machine 160 for each user account record and, depending on the embodiment, each subscription associated with that user account record.

A state machine 160 models a set of possible subscription states 162 for a subscription. At any given time, a subscription is said to be in one and only one of the subscription states 162 modeled by the state machine 160. In a simple embodiment, the subscription states 162 may simply be activated and deactivated. A client 110 having a subscription (i.e. being associated with a user account record for which there is a subscription) in the activated state is generally authorized for access to the content associated with that subscription, as discussed subsequently. A client 110 having a subscription in the deactivated state is generally not authorized for access to that content.

In an embodiment, the state machine may further model a grace state. Generally, a subscription is in a grace state when it has technically expired, but for various reasons still permits access to some or all of the content associated with the subscription, in accordance with access rules 175 associated with the grace state.

In an embodiment, the state machine may further model a suspend state. Generally, a subscription is in a suspend state when it has technically expired, but not yet been deactivated. The suspend state may or may not permit access to some or all of the content associated with that subscription. If a state machine 160 models both a suspend state and a grace state, the suspend state typically (but not necessarily) provides access to less content, or lower quality content, than the grace state.

In an embodiment, the state machine further models a parking state. Generally, a subscription is in the parking state when a subscription request has been received in association with a user account record, but one or more subscription eligibility criteria were not met. For instance, there may not have been enough money in an associated financial account to bill the subscription, or critical information for setting up the user account record may not yet have been provided. The parking state may or may not permit access to some or all of the content associated with the subscription, depending on the embodiment.

In other embodiments, additional states 162 are possible. Furthermore, more than one activation, deactivation, grace, suspend, or parking state may exist, having different associated transitions 164 and/or access rules 175.

Some or all of the subscription states 162 may be associated with actions that system 100 should automatically take upon entering and/or exiting from the state 162. For instance, a simple action may be sending a notification to a carrier, user, and/or merchant upon entering a state 162. Other actions may be related to subscription management, synchronization of data between systems, and so forth. System 100 may also or instead be configured to take certain actions only when a user account record is in a designated state, though the actions are not necessarily performed automatically upon entry to the state.

2.10. Events and State Transitions

A state machine 160 further models state transitions 164 that transition from a first specified state in the state machine 160 to a second specified state in the state machine 160. A state transition 164 is triggered by one or more specified triggering events. The state machine 160 “receives” these triggering events by reading log records, generated by other components of system 100, that describe the events and/or by monitoring for and receiving event messages that describe the events.

Triggering events may include, for instance, events 135 generated by subscription management component 120. Examples of events 135 may include, without limitation: subscription request events generated when a client 110 requests a new subscription, new subscription events generated when a new subscription is successfully generated, renewal events generated when a subscription is renewed, subscription failure events generated when a subscription fails and/or when fallback logic 126 has exhausted all fall back subscription options, and so on. Triggering events may include a variety of other events. One such event may be the receipt of certain requests or instructions from a client 110 associated with the relevant user account record for a subscription, which would be detected by a web-based or API server component. Another such event may be the lapsing of a certain amount of time since an event or state transition, which would be detected by a scheduling or timing component.

When the state machine 160 is in a first state for a user account record, upon the occurrence of all of the triggering event(s) associated with a state transition that transitions away from the first state, the state machine 160 transitions the subscription state from the first state to a second state specified by the state transition. For instance, a state machine may have an activated state, a deactivated state, and a suspend state. State transitions from the activated state may include a trivial renewal transition that transitions back to the activated state when a renewal event is received, a deactivate transition that transitions to the deactivation state when a deactivation request event is received, and a suspend transition that transitions to the suspend state when a renewal failure event occurs.

Different state transitions 164 may be associated with the same triggering event(s), so long as there is only ever one state transition triggered by the event(s) when the state machine 160 is in a given state. For instance, when state machine 160 is in the activated state, a renewal failure event may trigger a transition to the grace state, and when state machine 160 is in the deactivated state, the same renewal failure event may trigger a transition to the suspend state. Of course, many other arrangements of states and state transitions are possible. Further non-limiting examples are given in subsequent sections.

2.11. Types of State Machines

In an embodiment, there are different types of state machines 160 for different carriers 190 and even, in some embodiments, for different types of subscriptions. The states 162 and/or state transitions 164 (e.g. the events that trigger a state transition) may be configured differently between types. In an embodiment, there may furthermore be state machine templates. Each type of state machine may begin with a state machine template. The template may include predefined configurable options, such as configurable state transition triggers. A carrier 190, distributor, or other suitable entity may generate a new state machine type by customizing the state machine template through these configurable options. An example set of state machine templates is defined subsequently.

Though the use of a formal state machine is advantageous in some embodiments, it should be noted that in other embodiments the executed program logic for tracking and transitioning between states need not be a formal state machine. Many techniques described herein may be practiced using any executed program logic that characterizes a subscription as being in a specific one of multiple subscription states and transitions between the subscription states based on triggering events, even when the program logic is not implemented using a formal state machine. Such executed program logic is considered to constitute an informal state machine for the purposes of this disclosure.

Not all state machines 160 need actually be instantiated at a given time. Rather, a state machine 160 may be generated when needed for processing events 135, “saved” using representative data in the relevant user account record when not needed, and then reconstructed using that representative data when needed again. Or, a state machine 160 may only be instantiated when a content authorization component 170 or other component needs to identify a current subscription state for a user account record. All events are recorded in a log. Any events related to the user account record may be “replayed” to the state machine 160 to determine the current subscription state of the user account record. The current state may be saved for future reference, thus allowing the logged events to be deleted, or the logged events may be replayed again the next time the current subscription state is needed.

2.12. Request Authorization and Access Rules

Each subscription state 162 is associated with one or more access rules 175. An access rule indicates whether clients 110 whose subscriptions are in the associated state are allowed to access certain content. An access rule may be general, in that it simply indicates that all content associated with a subscription may or may not be accessed, or an access rule may be specific, in that it indicates that specific items or categories of items may or may not be accessed. An access rule may further indicate what versions of content may be accessed (e.g. high-definition versus low-definition, or teaser versus full content). An access rule may also indicate certain constraints upon a clients' 110 access to content (e.g. a type of device that must be used, whether advertisements should be shown, a time period in which the content must be viewed, etc.). A variety of other types of access rules may also be implemented.

System 100 further comprises one or more content authorization components 170 that decide whether to allow a client 110 to access certain content based on the access rules 175 associated with the current state of a client 110's subscription(s). A content authorization component 170 receives requests to authorize a client 110 to access a specific item of content provided by the one or more content distribution systems. Requests may specify a client identifier for the client 110, and/or a user account record identifier. Requests may be received from clients 110, either directly or via redirection from a carrier system 190 or content distribution system. Or, requests may be received from carrier systems 190 or content distribution systems, on behalf of clients 110.

When a request for content authorization is received by a content authorization component 170, the content authorization component 170 identifies the subscription state of the relevant user account record using the appropriate state machine 160 or saved subscription state data, as retrieved via the user record access component 140. The authorization component 170 then identifies any access rules 175 associated with the current subscription state. Based on the associated access rules 175, the content authorization component 170 determines whether to allow access to the requested content. In embodiments where a user account record may have multiple subscriptions, the content authorization component 170 may be configured to perform the foregoing for each subscription, or at least a subset of the subscriptions that is associated with the content. If the access rules associated with a current subscription state permit access, then the user account record is permitted access.

For requests from the client 110, the content authorization component 170 then redirects the client 110 to a source from which the content may be retrieved, if access is allowed. If access is not allowed, the content authorization component 170 responds with an indication that access is not allowed and/or redirects the client to a page where the client may attempt to activate or renew a subscription that will permit access. For requests from sources other than the client 110, the content authorization component 170 simply responds with an indication of whether or not access is allowed. In some embodiments, if an access rule includes instructions that affect the manner in which the content should be presented (e.g. using advertisements, or only partial access), the content authorization component 170 may also relay such instructions to a device responsible for ensuring that the instructions will be followed, such as the client or the content source server.

2.13. Configuration Interface

System 100 further comprises one or more configuration interfaces 180. A configuration interface 180 provides interfaces for configuring various aspects of system 100 on a per-carrier basis. For instance, a carrier system 190 may send instructions through configuration interface 180 that instruct system 100 to modify access rules 175, state transitions 164, subscription eligibility criteria, fallback logic 126, or retry logic 124 for one or more subscriptions related to the carrier. The instructions may be submitted via a web interface in response to web pages sent by a web server that implements the configuration interface 180. Or, the instructions may be submitted programmatically via an API. A configuration component within system 100 is configured to execute any processes necessary to reconfigure system 100 in response to the received instructions.

In an embodiment, configuration interface 180 is more generally part of a set of APIs or web interfaces that provide a number of other functionalities to carriers 190, such as subscription reporting, user account record management or synchronization, billing integration, authorization services, content hosting, and so forth.

2.14. Miscellaneous

In an embodiment, system 100 is a secure Hyper-Text Transport Proctocol (HTTP) based system. The interactions between the components of system 100 are HTTP-based, and secured with suitable authentication protocol(s). For instance, interactions between each of the following pairs of components may be required to take place using a secure protocol such as HTTP over SSL (HTTPS): client 110 and subscription management component 120, client 110 and content authorization component 170, external system 190 and subscription eligibility criteria verification component 130, and external system 190 and configuration interface 180.

System 100 illustrates only one of many possible arrangements of components configured to provide the functionality described herein. Other arrangements may include fewer, additional, or different components, and the division of work between the components may vary depending on the arrangement. For example, in some embodiments, a subscription management component 120 and/or a subscription criteria verification component 130 may be found in some or each of external systems 190 rather than system 100.

In FIG. 1, as in other drawings herein, the various components of system 100 are depicted as being communicatively coupled to various other components by arrows. These arrows illustrate only certain examples of information flows between the components of system 100. Neither the direction of the arrows nor the lack of arrow lines between certain components should be interpreted as indicating the existence or absence of communication between the certain components themselves. Indeed, each component of system 100 may feature an open port, API, or other suitable communication interface by which the component may become communicatively coupled to other components of system 100 as needed to accomplish any of the functions of system 100 described herein.

### 3.0. FUNCTIONAL OVERVIEW

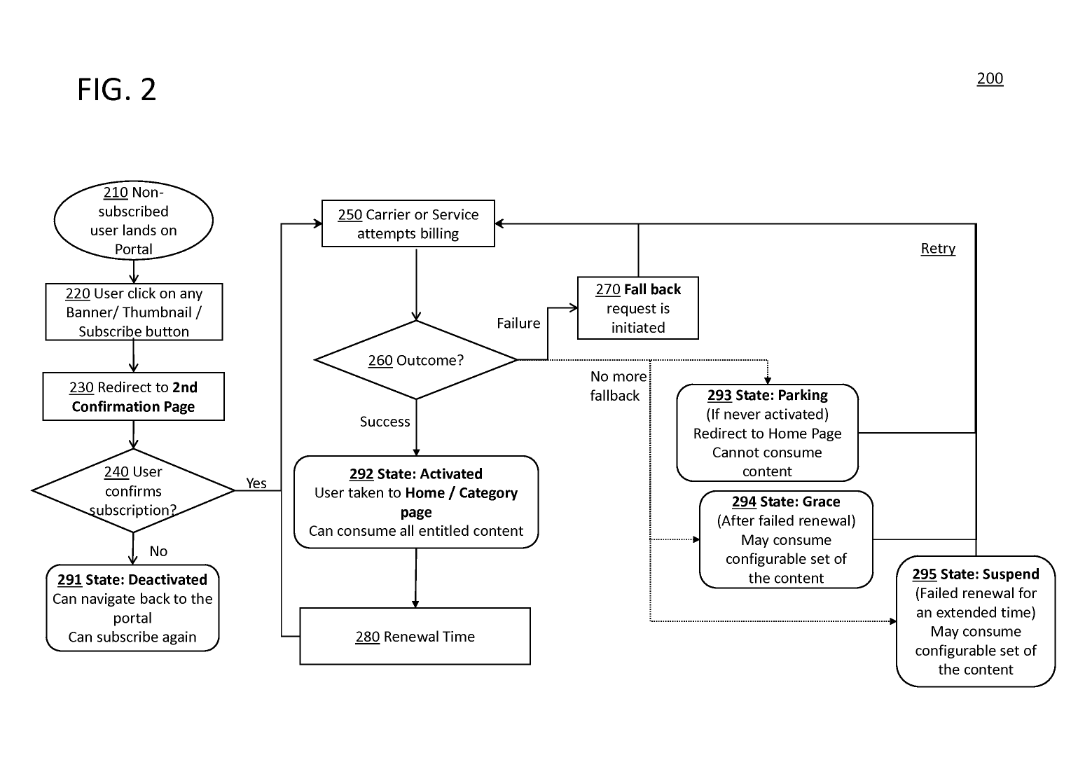

In an embodiment, providing access to subscription-based content subscriptions is greatly simplified using state-based techniques that take advantage of a centralized authorization such as described above. FIG. 2 illustrates an example flow 200 for management of a subscription state, according to an embodiment. The various elements of flow 200 may be performed in a variety of systems, including systems such as system 100 described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

Block 210 of flow 200 comprises a client, operated by a user who does not have a user account or has a non-subscribed user account record, landing on a portal page, such as a home page of a content distribution web site or a start screen of a mobile application. For instance, a client 110 may request a page hosted by one or more web servers of system 100 or one of carrier systems 190, or open an application distributed on behalf of system 100 or carrier system 190.

Block 220 comprises a user clicking on or otherwise selecting a subscribe control within the portal page. The subscribe control may be any suitable type of control, such as a banner, a thumbnail for content included in the subscription, a “subscribe” or “watch now” button, and so forth. The portal page may or may not contain information about the subscription, such as eligibility criteria or associated content. In response to the user clicking on the control, the portal page is configured to cause the client to send a subscribe request to the content authorization system. For instance, a client 110 may send a subscribe request to one of carrier systems 190. Or, a client 110 may send a subscribe request to subscription management component 120. In some embodiments, the selected subscription control selects one of a number of possible subscriptions, and the subscribe request indicates the selected subscription.

Block 230 comprises redirecting the client to a second confirmation page. For instance, the client's web browser may be directed to a consent gateway that delivers a consent page to the client. The consent page may include more detailed information about the subscription. For instance, a client 110 may be receive consent information from a server that implements subscription management component 120.

Block 240 comprises determining whether the user confirms that the user wishes to enable to the subscription. The user may do so by selecting a confirmation control, such as a button, link, check box, or other suitable control, within the consent page. Optionally, the consent page may include additional controls in which the user is required to input certain information before selecting the confirmation control, such as a user name or other account information, financial account information, and so forth. The confirmation control causes the client to submit a consent acknowledgment message (e.g. to subscription management component 120), which may include any additional information entered by the user. If no consent acknowledgment message is received, flow proceeds to block 291, in which the user account record is placed in a deactivated state. In this state, the user's client device cannot access content associated with the subscription, but may access the portal page and attempt to subscribe again.

If, however, a consent acknowledgment message is received, flow proceeds to block 250, in which a carrier or service attempts to bill for the subscription, or otherwise verify subscription eligibility criteria. For instance, subscription management component 120 may request that a subscription eligibility criteria verification component 130 attempt to bill a specified financial account associated with the user for the subscription requested in block 220. This block may involve identifying a suitable billing component to send the request to based on the carrier and/or financial account information entered by the user or otherwise associated with the user account record.

Block 260 comprises branching based on the outcome of block 250. If billing was successful, flow proceeds to block 292, in which the user account record is placed in an activated state. In this state, the user's client device can access any content associated with the subscription. The user account record remains in this state until, in block 280, a renewal time is reached. The renewal time is generally scheduled or detected as a function of the length of the subscription, as described in other sections. At the renewal time, flow returns to block 250.

If billing in block 250 is not successful, then flow may proceed down one of two different paths. If fallback subscriptions are available, flow may proceed to block 270, where a fallback subscription request is initiated. For instance, a subscription request may be made for a lower-quality or shorter term version of the subscription requested in block 220. Blocks 270, 250, and 260 may loop a number of times if a number of fallback subscription options are available but not successfully billed. In each iteration of the loop, a less-preferred subscription alternative is attempted than in the last iteration.

When each of the available fallback subscription options have finally been attempted, if block 250 still fails, then flow proceeds to one or blocks 293, 294, or 295, depending on various factors. If the subscription has never been successfully activated for the user account record, flow proceeds to block 293, in which the user account record is placed in a parking state. In this state, the user cannot consume content, as in block 291. However, flow may subsequently proceed from block 293 back to block 250 in accordance to retry logic such as retry logic 124, so that the user may eventually obtain a subscription if sufficient funds for the subscription become available. Depending on the embodiment, when the retry logic returns to block 250, the initially requested subscription may again be requested, and all of the fallback options tested anew if necessary.

If the subscription has been successfully activated for the user account record, but a renewal has failed, and if the time since the subscription expired or the first renewal attempt failed is less than some threshold amount, or if less than a certain number of retry attempts have been made, flow proceeds to block 294. At block 294, the user account record is placed in a grace state. In the grace state, the user account record is still authorized to access at least a configurable set of content from the subscription. Flow may also return from block 294 to block 250 using the retry logic, as explained with respect to block 293.

If the subscription has been successfully activated for the user account record, but a renewal has failed, and if the time since the subscription expired or the first renewal attempt failed is greater than some threshold amount, or if more than a certain number of retry attempts have been made, flow proceeds to block 295. At block 295, the user account record is placed in a suspend state. In the suspend state, depending on the embodiment and associated access rules, the user account record may still be authorized to access at least a configurable set of content from the subscription, though the level of access will typically be reduced relative to the suspend state. Flow may also return from block 295 to block 250 using the retry logic, as explained with respect to block 293. Though not depicted, flow may eventually proceed from block 295 to block 291 if a certain amount of time has passed or number of retry attempts have been made since entering the suspend state.

Flow 200 illustrates only one of many possible arrangements of steps to provide the functionality described herein. Other arrangements may include fewer, additional, or different functional blocks, depending on the arrangement. For instance, in some embodiments, block 270 may be omitted. In other embodiments, block 250 is not retried after failure. In yet other embodiments, some or all of the parking, grace, and suspend state may be omitted. In yet other embodiments, blocks 230 and 240 are optional.

### 4.0. IMPLEMENTATION EXAMPLES

4.1. Content Distribution System Supporting Bifurcated Subscription Management

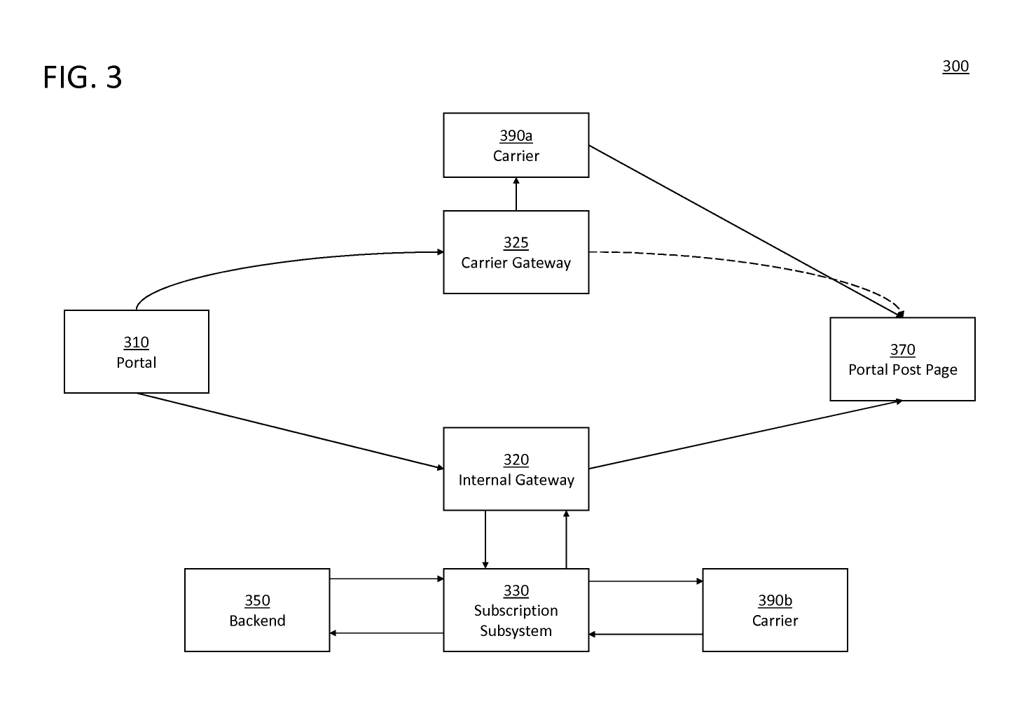

FIG. 3 illustrates an example content distribution system 300 that supports bifurcated subscription management, according to an embodiment. A content distributor hosts a portal 310, such as a website or application, which clients may interact with. Depending on an identity of a carrier through which the clients gained access to the portal 310, when clients request access to content to which they are not subscribed, the clients may be redirected either to a carrier gateway 325 or an internal gateway 320.

For certain carriers, such as the carrier operating the depicted carrier system 390a, clients may be directed to carrier gateway 325. The carrier gateway 325 may function much as the subscription management subsystem 120 of system 100, but be operated by carrier system 390a. For instance, the carrier gateway 325 may provide information about the requested subscription, request confirmation of user consent to the subscription, interact with one or more billing components or other subscription eligibility criteria verification components, and so forth. The carrier system 390a asynchronously sends events related to the subscription to the content distributor. For instance, the carrier system 390a may send subscribe, renewal, and renewal failures messages to a state machine component operated by the content distributor. From carrier gateway 325, clients are redirected to portal post page 370, from which the clients may obtain content if they enter an appropriate activation state as a result of interaction with consent gateway 325.

For other carriers, such as the carrier operating the depicted carrier system 390b, clients may be directed to internal gateway 320. The internal gateway 320 requests confirmation of a requested subscription and then initiates various subscription processes at the subscription subsystem 330. Subscription subsystem 330 may, for instance, include the subscribe logic 122 of system 100. As depicted, subscription subsystem 330 may interact with carrier 390b for various purposes, such as for billing and/or other subscription eligibility criteria verification processes. However, subscription subsystem 330 may also or instead interact with other billing and/or other subscription eligibility criteria verification components. Subscription subsystem 330 may furthermore interact with a backend component 350, which may asynchronously provide optional functionality such as retry logic 124 or fallback logic 126. The backend component 330 may further manage state machines and access rules, as needed. Once a client has interacted with the internal gateway 320, the client is likewise directed to the portal post page 370.

In an embodiment, the content distributor may provide a configuration interface by which carrier systems 390 may configure the operation of various components in system 300. For instance, the configuration interface may allow a carrier system 390 to directly modify the appearance and behavior of the portal 310, portal post page 370, the redirections to and from the carrier gateway 325, and the functionality of the backend 350.

System 300 illustrates only one of many possible arrangements of components configured to provide the functionality described herein. Other arrangements may include fewer, additional, or different components, and the division of work between the components may vary depending on the arrangement. Although system 100 and system 300 include some similar components, and in some embodiments may in fact be merged into single system, each system is by itself a separate example of the systems in which the described techniques may be practiced.

4.2. Example Platform Architecture

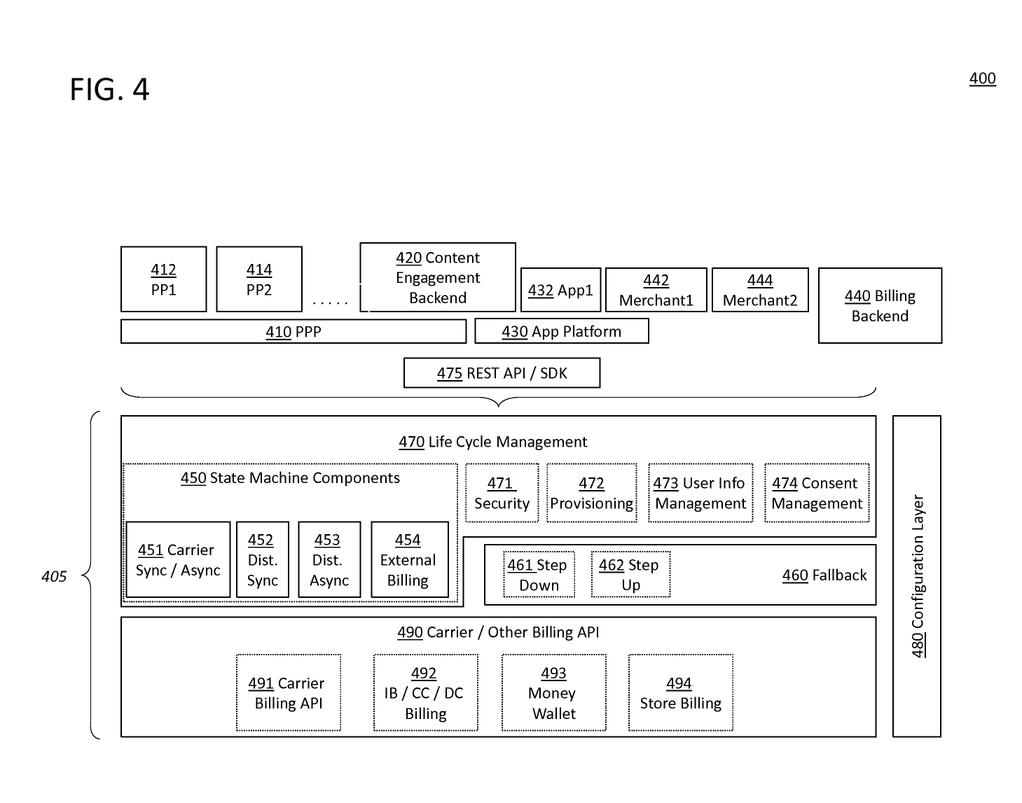

FIG. 4 illustrates an example architecture 400 for supporting supports multiple carriers using a centralized content distribution system, according to an embodiment. Architecture 400 includes a premium product platform 410 by which multiple premium products, such as products 412 and 412 are provided to client devices. The products may be any sort of electronic content. A content engagement backend 420 is further provided for marketing and other purposes. An application platform 430 is provided, and may support multiple applications such as application 432. An application 432 may be a smartphone application, tablet application, set-top box application, desktop application, or any other suitable application. An application 432, which may be created and distributed by the carrier or the content distributor, provides access to the premium products through communication with the content distributor's servers.

Architecture 400 supports integration with multiple merchants, such as merchants 442 and merchant 444, for distributing their own content on the content distribution network. To this end, a billing backend 440 is provided for transacting with the merchants.

The above-described components utilize an interface 475 to communicate with a life cycle management component 470, which provides subscription management and content authorization services for the content distributor. The life cycle management component includes state machine components 450, which are similar to state machine components 150. Four different types of state machines 451-454 are depicted, though there may in fact be any number of types of state machine components in other embodiments. The life cycle management component 470 further includes a security component 471 for securing transactions, content, and/or user information. The life cycle management component 470 further includes a user information management component 473 for setting up and managing user account records. The life cycle management component 470 further includes a provisioning component 472 for setting up subscriptions, and associating user account records and subscriptions with client devices. The life cycle management component 470 further includes a consent management component 474 for soliciting and receiving user consent to enroll in subscriptions.

Coupled to life cycle management component 470 is a billing interface 490 for billing financial accounts as needed to meet subscription criteria. Billing interface 490 includes a number of subcomponents for different types of financial accounts, including a carrier billing API 491, credit and debit billing API 492, money wallet billing API 493, and store billing API 494.

Further coupled to life cycle management component 470 is fallback component 460 configured to execute fallback logic for subscriptions. The fallback component 460 may include step down logic 461 for stepping down to lower subscription levels when funds are not available for higher levels. The fallback component 460 may include step up logic 462 for stepping up to higher subscription levels when funds are available again.

Architecture 400 further includes a configuration interface 480. Configuration interface 480 receives carrier-specific configuration instructions from carriers that configure the various components and subcomponents in life cycle management component 470, fallback component 460, and billing interfaces 490, as described in other sections.

System 400 illustrates only one of many possible arrangements of components configured to provide the functionality described herein. Other arrangements may include fewer, additional, or different components, and the division of work between the components may vary depending on the arrangement. Although system 400 includes some components that are similar to those found in system 300 and/or system 100, and in some embodiments may in fact be merged into single system with system 300 and/or system 100, each system is by itself a separate example of the systems in which the described techniques may be practiced.

4.3. Example State Machines

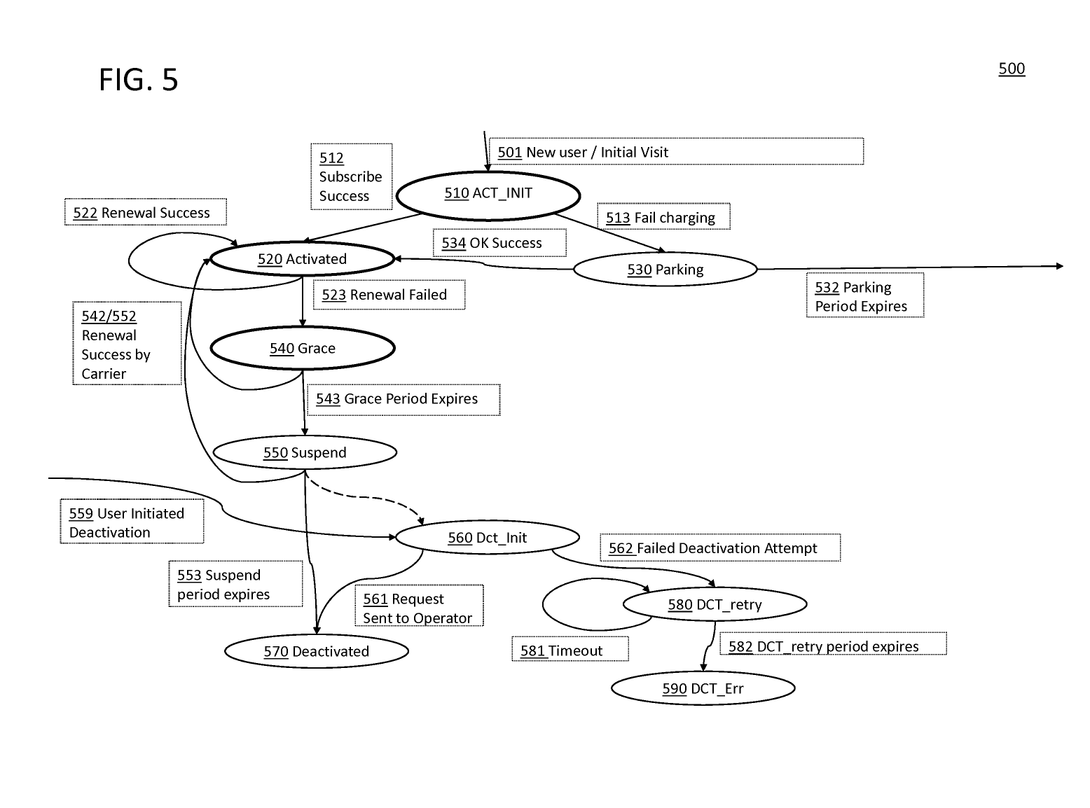

FIGS. 5-8 illustrate example state machines. These state machines comprise subscription states, which are depicted as ovals, and state transitions, which are depicted as arrows extended from one state to another and labeled using dotted rectangles. A state machine is always considered to be in a state, and remains in that state until an outward-bound transition is triggered. A state's outward-bound transitions are those whose arrows point away from the state. The state to which the arrow points is the state into which a state transition proceeds when the transition is triggered. A state machine is said to be triggered in response to an event message (or event for short), which, depending on the embodiment, should be understood as corresponding to the act of receiving a data structure representing the event message over an open port, or reading such a data structure from a log, queue, or other data repository.

The examples illustrate but some of the many types of state machines that are possible using the described techniques. Other state machines may include additional states and transitions in varying arrangements. Although the depicted state transitions are typically triggered by billing-related events, it will be understood that these events may be, in other embodiments, verifications (or lack thereof) of any suitable subscription eligibility criteria.

The illustrated state machines may be used, in certain embodiments, as templates. In these templates, the events that trigger the various state transitions of may be configurable using a configuration interface. Thereby, different types of state machines may be created for different carriers or for other purposes. For instance, the amounts of time before certain state transitions are triggered may be configurable, such that different types of state machines may be created from the same template as a result of carriers configuring these amounts of time differently. Moreover, in some embodiments, through the configuration interface, additional state transitions and/or states may be added to create custom types of state machines.

For illustrative purposes, examples of subscription states in which content may be accessed are bolded. However, in other embodiments, configurable access rules may also allow access to content in other states, and/or deny access to content in some of the states that are bolded.

FIG. 5 illustrates an example state machine 500 conforming to a template for carrier-managed subscriptions, according to an embodiment. Because the carrier manages various aspects of the subscription life cycle, such as billing and payment, the state machine is optimized for a content authorization system configured to operate under the assumption that it may receive certain events, user account data, subscription data, and other data asynchronously relative to any processing by the carrier.

State machine 500 begins with an initial transition 501, which is triggered in response to an event message indicating an initial request from a new user for a subscription. For instance, a user may land at the carrier's consent gateway, which offers information about the subscription and requests confirmation of the user's intent to create a user account and enroll in the subscription. Up until this transition, the user is technically considered to be in a deactivation state, such as deactivation state 570. After this transition, the user is considered to be in a ACT_INIT state 510, and remains in this state until an outward transition is triggered.

The ACT_INIT state 510 has two outward transitions: transitions 512 and 513. Transition 512 leads to activated state 520, and is triggered in response to an event message indicating that the carrier has successfully billed the fee for the subscription to a financial account associated with the user account record. For simplicity, the billing of a subscription fee to a financial account associated with a user account record may simply be referred to herein as a charge or the act of charging. Transition 513 leads to parking state 530, and is triggered in response to an event message from the carrier system indicating a failed charge (e.g. as a result of a low balance).

The activated state 520 has two outward transitions: transitions 522 and 523. Transition 522 leads back to activated state 520, and is triggered in response to an event message from the carrier system indicating a successful renewal. Such an event message may be received, for instance, towards the end of the subscription period in response to another successful charging of the subscription fee. Transition 523 leads to grace state 540, and is triggered in response to one of the following: an event message from the carrier system indicating a failed renewal, or an event message indicating that a client device associated with the user account record accessed a content portal associated with the subscription after the subscription period has expired without a renewal.

The parking state 530 has two outward transitions: transitions 532 and 534. Transition 532 is triggered in response to an event message indicating that a maximum period of time that the user account record may remain in the parking state has expired. This maximum period may be configurable by the carrier system, in certain embodiments. Transition 532 moves the user account record from the state machine, in that the user account record is no longer considered to be in any subscription state. Transition 534 leads to activated state 520, and is triggered in response to an event message from the carrier system indicating a successful charging. Such an event message may be received, for instance, in response to the carrier system making repeated attempts to complete the charge through carrier-hosted retry logic. Depending on the carrier's configuration instructions, the parking state 530 may or may not permit access to content or subsets of content in the subscription.

The grace state 540 has two outward transitions: transitions 542 and 543. Transition 542 leads back to activated state 520, and is triggered in response to an event message from the carrier system indicating a successful renewal. Transition 543 leads to suspend state 550, and is triggered in response to an event message from the carrier system notifying that a grace period of time has expired. The carrier system may, for example, send such a message out within 3 to 7 days of the user account record entering the grace state. Depending on the carrier's configuration instructions, the grace state 540 may or may not permit access to content or subsets of content in the subscription.

The suspend state 550 has two outward transitions: transitions 552 and 553. Transition 552 leads back to activated state 520, and is triggered in response to an event message from the carrier system indicating a successful renewal. Transition 553 leads to deactivated state 570, and is triggered in response to an event message from the carrier system notifying that a suspend period of time has expired. The carrier system may, for example, send such a message out within 3 to 7 days of the user account record entering the suspend state. Depending on the carrier's configuration instructions, the suspend state 550 may or may not permit access to content or subsets of content in the subscription.

A transition 559 is also depicted. Though not depicted as such to simplify FIG. 5, transition 559 may actually be an outward transition from any state of state machine 500. Transition 559 leads to DCT_Init state 560, and is triggered in response to an event message indicating an explicit deactivation request from the user associated with the user account record.

The DCT_Init state 560 has two outward transitions: transitions 561 and 562. Transition 561 leads to deactivated state 570, and is triggered in response to an event message indicating that the deactivation request has been successfully sent to the carrier system. Transition 561 leads to DCT_retry state 580, and is triggered by an event message indicating that the deactivation attempt was unsuccessful. The DCT_Retry state 580, which is typically entered only in unusual circumstances, is associated with rules that cause the content distribution system to retry the deactivation request. A timeout transition 581 leads back to the DCT_Retry state 580 for another attempt after a designated timeout period, while a transition 582 is triggered after a designated DCT_Retry period expires. Transition 590 leads to a DCT_Err state, which is associated with rules that cause an administrator of the content distribution system to be notified of a deactivation error.

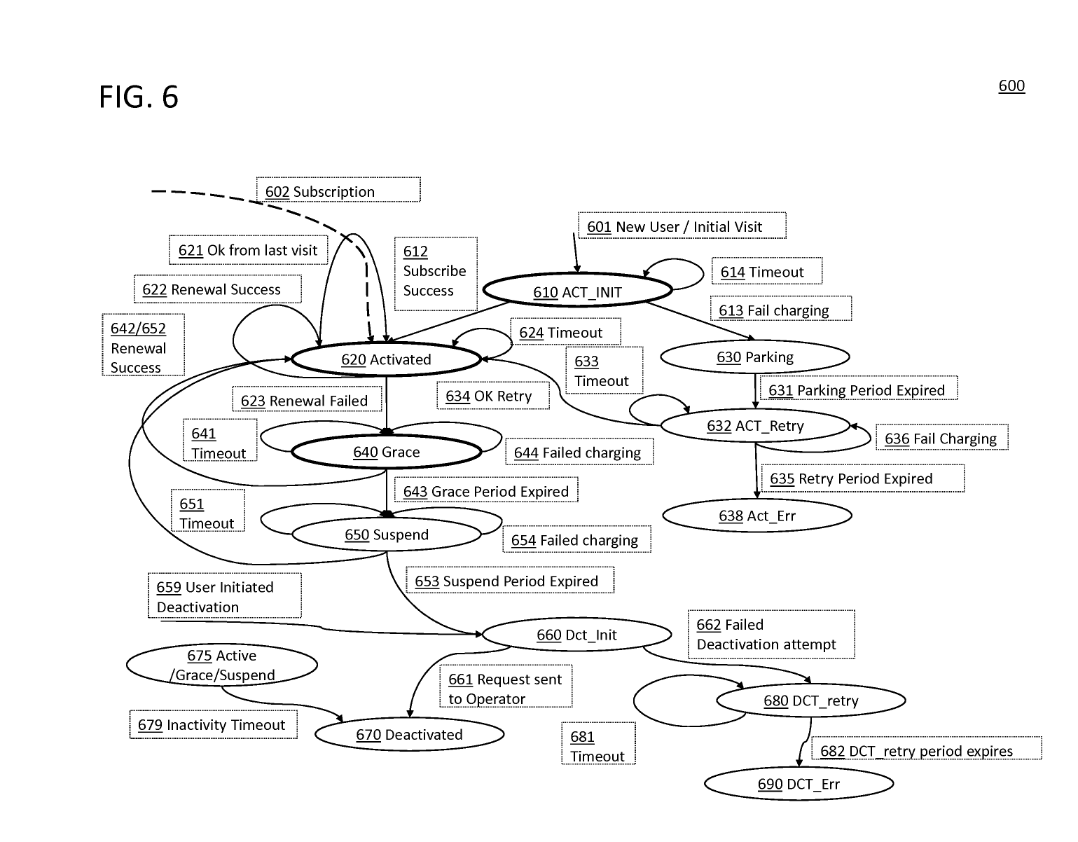

FIG. 6 illustrates an example state machine 600 conforming to a template for asynchronous centrally-managed subscriptions, according to an embodiment. The state machine is optimized under the assumption that the content authorization system is responsible for life-cycle management of the subscription, and communicates with the carrier system asynchronously with respect to billing request or events, data changes, and so forth.

State machine 600 begins with an initial transition 601, which is triggered in response to an event message indicating an initial request from a new user for a subscription. For instance, a user may land at a consent gateway, which offers information about the subscription and requests confirmation of the user's intent to create a user account and enroll in the subscription. Up until this transition, the user is technically considered to be in a deactivation state, such as deactivation state 670. After this transition, the user is considered to be in a ACT_INIT state 610, and remains in this state until an outward transition is triggered.

The ACT_INIT state 610 has three depicted outward transitions: transitions 612, 613, and 614. Transition 612 leads to activated state 620, and is triggered in response to an event message from a billing component indicating a successful charge. Transition 613 leads to parking state 630, and is triggered in response to an event message indicating a failed charge. Transition 614 is a timeout transition. As used herein, a timeout transition is transition that leads to and from the same state. A timeout transition is triggered by an event message indicating that an expected operation, such as initiating or charge or requesting information from a component, could not be completed in a designated amount of time. A timeout transition may result in repeating certain actions associated with entering a state.

The activated state 620 has four depicted outward transitions: transitions 621-624. Transition 621 leads back to activated state 620, and is triggered in response to an event message indicating a portal visit from a client device that is associated with a user account record known to still have a valid subscription based on another recent interaction. Transition 622 leads back to activated state 620, and is triggered in response to an event message indicating a successful renewal. Transition 623 leads to grace state 640, and is triggered in response to one of the following: an event message from the carrier system indicating a failed renewal; or an event message indicating that a client device associated with the user account record accessed a content portal associated with the subscription after the subscription period has expired without a renewal. Transition 624 is a timeout transition.

The activated state 620 has an additional inward transition in the form of initial transition 602, which may be triggered by an event message indicating that a content distribution portal is being accessed by a client associated with a subscribed user account record that was not previously in a state machine for various reasons.

The parking state 630 has one depicted outward transition 631. Transition 631 leads to ACT_Retry state 632, and is triggered in response to the expiration of a carrier-configurable parking period. For instance, the parking period may be a day or two in an embodiment. Depending on the carrier's configuration instructions, the parking state 630 may or may not permit access to content or subsets of content in the subscription.

ACT_Retry state 632 has four depicted outward transitions: transitions 633-636. Transition 633 is a timeout transition. Transition 634 leads to activated state 620, and is triggered in response to an event message indicating a successful charge. Such an event message may be received, for instance, through the execution of retry logic. Transition 636 leads back to ACT_Retry state 632, and is triggered in response to an event message indicating another failed charge. In an embodiment, entry into ACT_Retry state 632 may cause another retry attempt. Hence, to constrain the number of retry attempts, the event message must indicate that a carrier-configurable period of time has passed since the last retry attempt. For instance, in one embodiment, a carrier system may instruct the content authorization system to retry one to three times per day for three to seven days. Transition 635 leads to ACT_Err state 638, and is triggered in response to an event message indicating that a maximum period of time that the retry attempts may be made for a user account record has expired. This maximum period may be configurable by the carrier system, in certain embodiments. Again, depending on the carrier's configuration instructions, the ACT_Retry state 632 may or may not permit access to content or subsets of content in the subscription. The ACT_Err state 638 does not permit access.

The grace state 640 has four depicted outward transitions: transitions 641-644. Transition 641 is a timeout transition. Transition 642 leads back to activated state 620, and is triggered in response to an event message indicating a successful renewal. Transition 643 leads to suspend state 650, and is triggered in response to an event message indicating that a carrier-configurable grace period of time has expired. Transition 644 leads back to grace state 640, and is triggered in response to an event message indicating another failed charge. As with transition 636, the content authorization system may be configured in such a manner that this event is repeated only after a carrier-configurable amount of time. Depending on the carrier's configuration instructions, the grace state 640 may or may not permit access to content or subsets of content in the subscription.

The suspend state 650 has four depicted outward transitions: transitions 651-654. Transition 651 is a timeout transition. Transition 652 leads back to activated state 620, and is triggered in response to an event message indicating a successful renewal. Transition 653 leads to DCT_init state 650, and is triggered in response to an event message indicating that a carrier-configurable suspend period of time has expired. Transition 654 leads back to suspend state 650, and is triggered in response to an event message indicating another failed charge. As with transition 636, the content authorization system may be configured in such a manner that this event is repeated only after a carrier-configurable amount of time. Depending on the carrier's configuration instructions, the suspend state 650 may or may not permit access to content or subsets of content in the subscription.

A transition 659 is also depicted. Though not depicted as such to simplify FIG. 6, transition 659 may actually be an outward transition from any state of state machine 600. Transition 659 leads to DCT_Init state 660, and is triggered in response to an event message indicating an explicit deactivation request from the user associated with the user account record.

The DCT_Init state 660 has two depicted outward transitions: transitions 661 and 662. Transition 661 leads to deactivated state 670, and is triggered in response to an event message indicating that the deactivation request has been successfully sent to the carrier system. Transition 661 leads to DCT_retry state 680, and is triggered by an event message indicating that the deactivation attempt was unsuccessful. The DCT_Retry state 680, which is typically entered only in unusual circumstances, is associated with rules that cause the content distribution system to retry the deactivation request. A timeout transition 681 leads back to the DCT_Retry state 680 for another attempt after a designated timeout period, while a transition 682 is triggered after a designated DCT_Retry period expires. Transition 690 leads to a DCT_Err state, which is associated with rules that cause an administrator of the content distribution system to be notified of a deactivation error.

A transition 679 is also depicted. Transition 679 is depicted as an outward transition from state 675, which is intended to represent any of activated state 620, grace state 640, or suspend state 650. Transition 679 is thus an outward transition from these states as well. Transition 679 leads to deactivated state 670, and is triggered in response to an event message indicating that a carrier-configurable inactivity period of time has occurred without any client associated with the user account record attempting to access content. For instance, the inactivity may be a designated amount of time such as thirty days, or a function of the length of subscription.

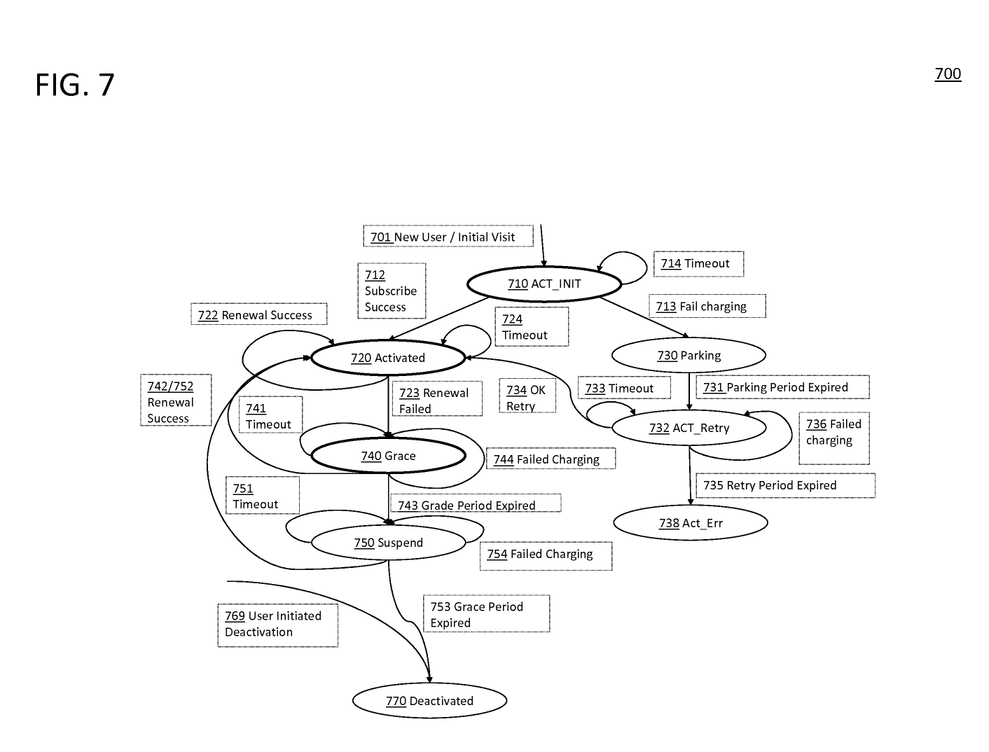

FIG. 7 illustrates an example state machine 700 conforming to a template for synchronous centrally-managed subscriptions, according to an embodiment. The state machine is optimized under the assumption that the content authorization system is responsible for life-cycle management of the subscription, and communicates with the carrier system synchronously with respect to billing request or events, data changes, and so forth.

State machine 700 begins with an initial transition 701, which is triggered in response to an event message indicating an initial request from a new user for a subscription. For instance, a user may land at a consent gateway, which offers information about the subscription and requests confirmation of the user's intent to create a user account and enroll in the subscription. Up until this transition, the user is technically considered to be in a deactivation state, such as deactivation state 770. After this transition, the user is considered to be in a ACT_INIT state 710, and remains in this state until an outward transition is triggered.

The ACT_INIT state 710 has three depicted outward transitions: transitions 712, 713, and 714. Transition 712 leads to activated state 720, and is triggered in response to an event message from a billing component indicating a successful charge. Transition 713 leads to parking state 730, and is triggered in response to an event message indicating a failed charge. Transition 714 is a timeout transition.

The activated state 720 has three depicted outward transitions: transitions 722-724. Transition 722 leads back to activated state 720, and is triggered in response to an event message indicating a successful renewal. Transition 723 leads to grace state 740, and is triggered in response to one of the following: an event message from the carrier system indicating a failed renewal; an event message indicating that a client device associated with the user account record accessed a content portal associated with the subscription and the subscription period has expired without a renewal. Transition 724 is a timeout transition.

The parking state 730 has one depicted outward transition 731. Transition 731 leads to ACT_Retry state 632, and is triggered in response to the expiration of a carrier-configurable parking period. For instance, the parking period may be a day or two in an embodiment. Depending on the carrier's configuration instructions, the parking state 730 may or may not permit access to content or subsets of content in the subscription.

ACT_Retry state 732 has four depicted outward transitions: transitions 733-736. Transition 733 is a timeout transition. Transition 734 leads to activated state 720, and is triggered in response to an event message indicating a successful charge. Transition 736 leads back to ACT_Retry state 732, and is triggered in response to an event message similar to that which triggers transition 636. Transition 735 leads to ACT_Err state 738, and is triggered in response to an event message similar to transition 635. Again, depending on the carrier's configuration instructions, the ACT_Retry state 732 may or may not permit access to content or subsets of content in the subscription. The ACT_Err state 738 does not permit access.

The grace state 740 has four depicted outward transitions: transitions 741-744. Transition 741 is a timeout transition. Transition 742 leads back to activated state 720, and is triggered in response to an event message indicating a successful renewal. Transition 743 leads to suspend state 750, and is triggered in response to an event message indicating that a carrier-configurable grace period of time has expired. Transition 744 leads back to grace state 740, and is triggered in response to an event message indicating another failed charge. As with transition 636, the content authorization system may be configured in such a manner that this event is repeated only after a carrier-configurable amount of time. Depending on the carrier's configuration instructions, the grace state 740 may or may not permit access to content or subsets of content in the subscription.

The suspend state 750 has four depicted outward transitions: transitions 751-754. Transition 751 is a timeout transition. Transition 752 leads back to activated state 720, and is triggered in response to an event message indicating a successful renewal. Transition 753 leads to deactivation state 770, and is triggered in response to an event message indicating that a carrier-configurable suspend period of time has expired. Transition 754 leads back to suspend state 750, and is triggered in response to an event message indicating another failed charge. As with transition 636, the content authorization system may be configured in such a manner that this event is repeated only after a carrier-configurable amount of time. Depending on the carrier's configuration instructions, the suspend state 750 may or may not permit access to content or subsets of content in the subscription.

A transition 769 is also depicted. Though not depicted as such to simplify FIG. 7, transition 769 may actually be an outward transition from any state of state machine 700. Transition 769 leads to deactivation state 770, and is triggered in response to an event message indicating an explicit deactivation request from the user associated with the user account record.

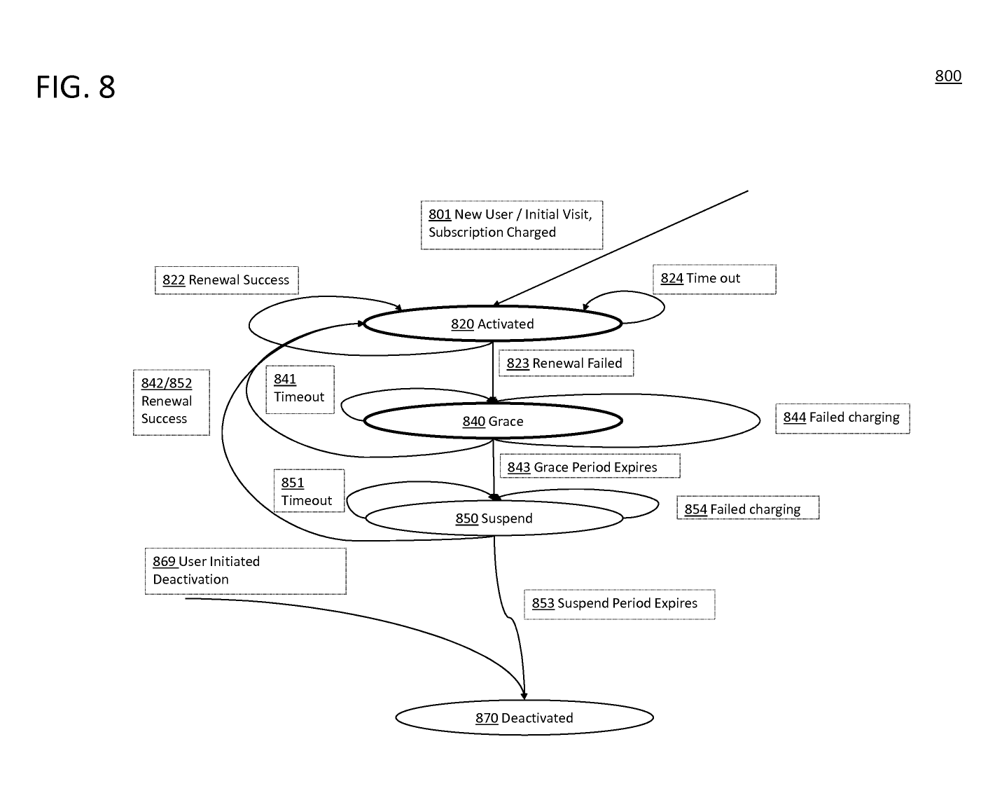

FIG. 8 illustrates an example state machine 800 conforming to a template for external billing options, according to an embodiment. The system is optimized for use in systems where the carrier is not involved in the billing process or subscription management.

State machine 800 begins with an initial transition 801, which is triggered in response to an event message indicating a successful charging for a subscription. Up until this transition, the user is technically considered to be in a deactivation state, such as deactivation state 870. After this transition, the user is considered to be in activated state 820, and remains in this state until an outward transition is triggered.

The activated state 820 has three depicted outward transitions: transitions 822-824. Transition 822 leads back to activated state 820, and is triggered in response to an event message indicating a successful renewal. Transition 823 leads to grace state 840, and is triggered in response to one of the following: an event message from the carrier system indicating a failed renewal; an event message indicating that a client device associated with the user account record accessed a content portal associated with the subscription and the subscription period has expired without a renewal. Transition 824 is a timeout transition.

The grace state 840 has four depicted outward transitions: transitions 841-844. Transition 841 is a timeout transition. Transition 842 leads back to activated state 820, and is triggered in response to an event message indicating a successful renewal. Transition 843 leads to suspend state 850, and is triggered in response to an event message indicating that a configurable grace period of time has expired. Transition 844 leads back to grace state 840, and is triggered in response to an event message indicating another failed charge. As with transition 636, the content authorization system may be configured in such a manner that this event is repeated only after a carrier-configurable amount of time. Depending on the embodiment, the grace state 840 may or may not permit access to content or subsets of content in the subscription.

The suspend state 850 has four depicted outward transitions: transitions 851-854. Transition 851 is a timeout transition. Transition 852 leads back to activated state 820, and is triggered in response to an event message indicating a successful renewal. Transition 853 leads to deactivation state 870, and is triggered in response to an event message indicating that a configurable suspend period of time has expired. Transition 854 leads back to suspend state 850, and is triggered in response to an event message indicating another failed charge. As with transition 636, the content authorization system may be configured in such a manner that this event is repeated only after a carrier-configurable amount of time. Depending on the embodiment, the suspend state 850 may or may not permit access to content or subsets of content in the subscription.

A transition 869 is also depicted. Though not depicted as such to simplify FIG. 8, transition 869 may actually be an outward transition from any state of state machine 800. Transition 869 leads to deactivation state 870, and is triggered in response to an event message indicating an explicit deactivation request from the user associated with the user account record.

4.4. Example Apis

According to an embodiment, various functionality described herein may be supported through application interfaces such as the following. A product interface is exposed to product providing systems. Example supported functions may include:
getBillingOptions (httpRequest, billingOptionID)
getUserID(httpRequest)
getUserStatus
activateUser
   Return options (Pass Callback URL)
      redirect link to CG
      redirect link to Vuclip
deactiveUser

A notification interface is exposed to registered merchants. Example supported functions may include:
Activation Notification
   Failed/Parking/Activated
Renewal Notification
   Activate/Grace/Suspend
Deactivation Notification
   Deactivated(Involuntary/voluntary)

A number of internal interfaces may also exist. For instance, one useful function may be a renewUser( ) function that is exposed for offline batch processing. These interfaces, or any other supporting interfaces, may be configured to require a secure communication protocol, such as HTTPS.

### 5.0. EXAMPLE EMBODIMENTS

Examples of some embodiments are represented, without limitation, in the following clauses.

According to an embodiment, a system comprises: one or more user account record access components configured to access user account records, the user account records having assigned subscription states, the subscription states having defined access rules; one or more subscription management components configured to activate and renew subscriptions for the user account records; and one or more authorization components configured to authorize client requests using specific access rules, of the access rules, that have been defined for specific subscription states, of the subscription states, that are currently assigned to associated user account records.

In an embodiment, the user account records pertain to multiple external systems. In an embodiment, the multiple external systems include at least two different network provider systems through which client devices associated with the user account records access content authorized by the one or more authorization components.

In an embodiment, the two different network provider systems host different billing systems, the one or more subscription management components configured to activate and renew first subscriptions by interacting with the different billing systems. In an embodiment, the one or more subscription management components are further configured to activate and renew second subscriptions by interacting with external billing systems not hosted by any of the multiple external systems.

In an embodiment, the system further comprises one or more external configuration interfaces configured to receive configuration instructions from or in association with external systems; and one or more configuration components configured to, based on a given instruction of the configuration instructions that is received from or in association with a given system of the external systems, configure one or more of: a given state transition to use for user account records that pertain to the given system, or a given access rule to use when user account records that pertain to the given system are in a given state.

In an embodiment, the one or more subscription management components are configured to activate and renew subscriptions for the user account records by at least: sending verification requests to subscription eligibility criteria verification components indicating the subscriptions and/or subscription eligibility criteria to verify, and determining whether to activate or renew the subscriptions based on responses to the verification requests. In an embodiment, the one or more subscription management components are configured to activate and renew subscriptions for the user account records by at least: requesting that external billing components bill subscription fees to identified financial accounts associated with the user account records, and determining whether to activate or renew the subscriptions based on whether the subscription fees are successfully billed.

In an embodiment, the subscription states include at least: an activated state, a deactivated state, and at least one of a grace state or a suspend state. In an embodiment, based on the access rules the authorization component is configured to, in response to a first client request for a first user account record, authorize access to first content when the first user account record is assigned to the activation state and to the grace state or the suspend state, and not when the first user account record is assigned to the deactivation state. In an embodiment, a first access rule associated with the grace state or the suspend state permits access to only a lesser-quality version of content permitted for a given subscription. In an embodiment, the subscription states include a grace state and a suspend state, the grace state being associated with an access rule that grants access to at least a first partial set of content permitted for a given subscription, the suspend state being associated with an access rule that grants access to no more than a second partial set of content permitted for the given subscription, second partial set being smaller than the first partial set.

In an embodiment, the system further comprises one or more state machine components configured to transition the user account records to different assigned subscription states when corresponding state transitions are triggered, at least some of the state transitions being triggered responsive to subscription event messages received from the one or more subscription components. In an embodiment, the one or more state machine components are configured to implement different types of state machines for different sets of user account records belonging to different external systems, the different types of state machines including differently-configured state transitions for transitioning between a same plurality of the subscription states. In an embodiment, at least some of the different types of state machines conform to different state machine templates selected from a set of state machine templates, the set of state machine templates being fewer in number than the different types of state machines.

In an embodiment, the one or more state machine components are configured to implement different types of state machines for different sets of user account records belonging to different external systems, wherein different access rules apply to a same state depending on which of the different types of state machines is maintaining the state, the different access rules having been configured in response to configuration instructions from the different external systems. In an embodiment, the one or more state machine components are configured to implement different types of state machines for different sets of user account records belonging to different external systems, wherein different access rules apply to a same state depending on which of the different types of state machines is used.

In an embodiment, a first subscription component of the one or more subscription components is configured to send an initial subscription event message to a first state machine component of the one or more state machine components when activating a new subscription for a user account record, the initial subscription event message triggering a transition to the activated state. In an embodiment, a first subscription component of the one or more subscription components is configured to send a renewal event message to a first state machine component of the one or more state machine components when renewing a subscription for a user account record, the renewal event message triggering a transition to the activated state.

In an embodiment, a first subscription component of the one or more subscription components is configured to send a renewal failure event message to a first state machine component of the one or more state machine components when an attempt to renew a subscription for a user account record fails, the renewal failure event message triggering a transition to the grace state or the suspend state. In an embodiment, wherein a scheduling component of the system is configured to send an event message indicating that a grace period or a suspend period is expired to a first state machine component of the one or more state machine components when an attempt to renew a subscription for a user account record fails, the event message triggering a transition away from the grace state or the suspend state.

In an embodiment, the subscription states include a parking state, wherein a first subscription component of the one or more subscription components is configured to send an initial subscription failure event message to a first state machine component of the one or more state machine components when failing to activate a new subscription for a user account record, the initial subscription failure event message triggering a transition to the parking state, wherein while the user account record has the parking state, at least one of the following is configured to occur occurs: the authorization component authorizes access to first content requested for the user account record; the first subscription component makes one or more additional attempts to activate the new subscription.

In an embodiment, the subscription management component comprises retry logic configured to, when an activation or renewal of a subscription fails, attempt to activate or renew the subscription one or more additional times. In an embodiment, the retry logic is configured to schedule the one or more additional times based on a previous history of successful and/or failed activation or renewal attempts.

In an embodiment, the subscription management component comprises fallback logic configured to, when an activation or renewal of a given subscription fails, attempt to activate or renew one or more lower-level subscriptions associated with the given subscription.

In an embodiment, the system may include any combination of the foregoing features described in this section as well as throughout this disclosure.

According to an embodiment, a system comprises: one or more user account record access components configured to access user account records; one or more subscription management components configured to activate and renew subscriptions for the user account records, the subscription management component comprising retry logic configured to, when an activation or renewal of a subscription fails, attempt to activate or renew the subscription one or more additional times; and one or more authorization components configured to authorize client requests using specific access rules associated with the subscriptions.

In an embodiment, the retry logic is configured to schedule the one or more additional times based on a previous history of successful and/or failed activation or renewal attempts.

In an embodiment, the system further comprises: one or more external configuration interfaces configured to receive configuration instructions from or in association with external systems; and one or more configuration components configured to, based on a given instruction of the configuration instructions that is received from or in association with a given system of the external systems, configure the retry logic for user account records that pertain to the given system.

In an embodiment, the system may include any combination of the foregoing features described in this section as well as throughout this disclosure.

According to an embodiment, a system comprises: one or more user account record access components configured to access user account records; one or more subscription management components configured to activate and renew subscriptions for the user account records, the subscription management component comprising fallback logic configured to, when an activation or renewal of a given subscription fails, attempt to activate or renew one or more lower-level subscriptions associated with the given subscription; and one or more authorization components configured to authorize client requests using specific access rules associated with the subscriptions.

In an embodiment, the system further comprises: one or more external configuration interfaces configured to receive configuration instructions from or in association with external systems; and one or more configuration components configured to, based on a given instruction of the configuration instructions that is received from or in association with a given system of the external systems, configure a fallback subscription plan for user account records that pertain to the given system, the fallback subscription plan specifying, for a first subscription, a set of one or more additional subscriptions to attempt.

In an embodiment, the one or more additional subscriptions have subscription fees that are within a fixed set of two or more amounts, the system being only allowed to bill a billing system hosted by the given system amounts in the fixed set. In an embodiment, the one or more additional subscriptions are of increasingly shorter terms of time, and/or provide increasingly less quality or quantity of content than the given subscription.

In an embodiment, the system may include any combination of the foregoing features described in this section as well as throughout this disclosure.

Other examples of these and other embodiments are found throughout this disclosure.

### 6.0. IMPLEMENTATION MECHANISM—HARDWARE OVERVIEW

According to one embodiment, the techniques described herein are implemented by one or more special-purpose computing devices. The special-purpose computing devices may be desktop computer systems, portable computer systems, handheld devices, networking devices or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

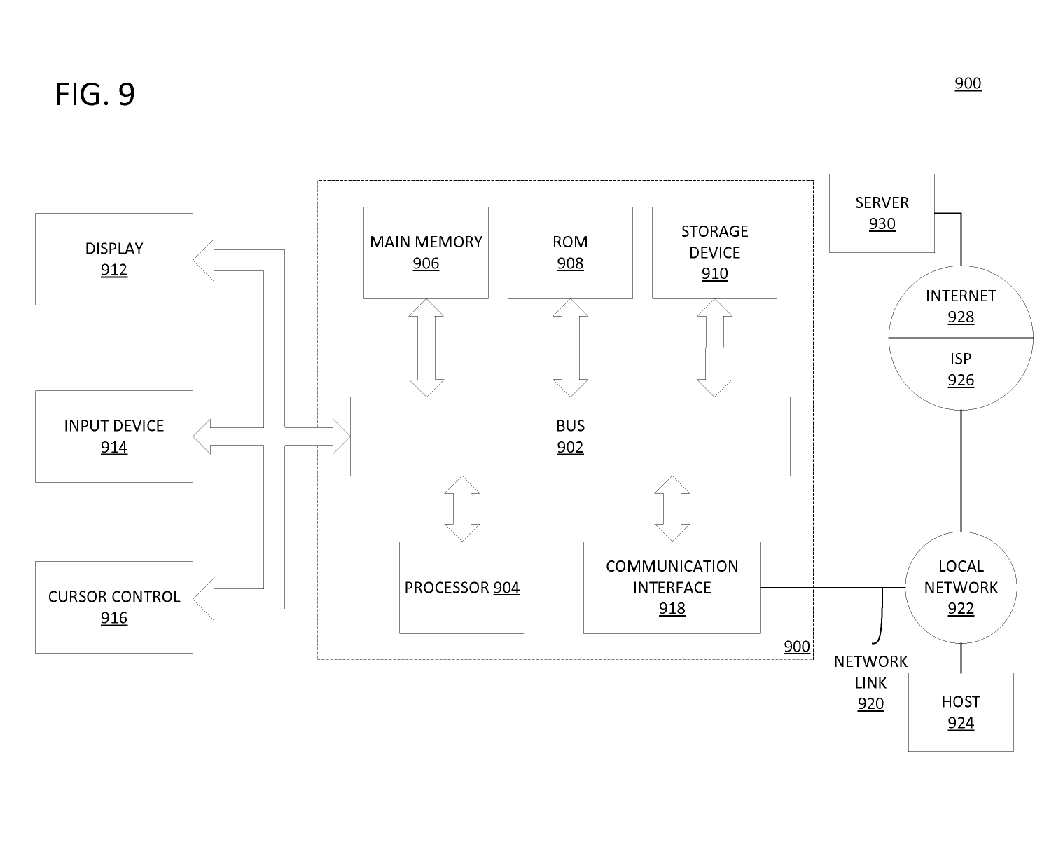

FIG. 9 is a block diagram that illustrates a computer system 900 utilized in implementing the above-described techniques, according to an embodiment. Computer system 900 may be, for example, a desktop computing device, laptop computing device, tablet, smartphone, server appliance, computing mainframe, multimedia device, handheld device, networking apparatus, or any other suitable device.

Computer system 900 includes one or more busses 902 or other communication mechanism for communicating information, and one or more hardware processors 904 coupled with busses 902 for processing information. Hardware processors 904 may be, for example, a general purpose microprocessor. Busses 902 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 900 also includes a main memory 906, such as a random access memory (RAM) or other dynamic or volatile storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes one or more read only memories (ROM) 908 or other static storage devices coupled to bus 902 for storing static information and instructions for processor 904. One or more storage devices 910, such as a solid-state drive (SSD), magnetic disk, optical disk, or other suitable non-volatile storage device, is provided and coupled to bus 902 for storing information and instructions.

Computer system 900 may be coupled via bus 902 to one or more displays 912 for presenting information to a computer user. For instance, computer system 900 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 912 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 912.

One or more input devices 914 are coupled to bus 902 for communicating information and command selections to processor 904. One example of an input device 914 is a keyboard, including alphanumeric and other keys. Another type of user input device 914 is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane. Yet other examples of suitable input devices 914 include a touch-screen panel affixed to a display 912, cameras, microphones, accelerometers, motion detectors, and/or other sensors. In an embodiment, a network-based input device 914 may be utilized. In such an embodiment, user input and/or other information or commands may be relayed via routers and/or switches on a Local Area Network (LAN) or other suitable shared network, or via a peer-to-peer network, from the input device 914 to a network link 920 on the computer system 900.

A computer system 900 may implement techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid state drive of a remote computer. The remote computer can load the instructions into its dynamic memory and use a modem to send the instructions over a network, such as a cable network or cellular network, as modulate signals. A modem local to computer system 900 can receive the data on the network and demodulate the signal to decode the transmitted instructions. Appropriate circuitry can then place the data on bus 902. Bus 902 carries the data to main memory 906, from which processor 904 retrieves and executes the instructions. The instructions received by main memory 906 may optionally be stored on storage device 910 either before or after execution by processor 904.

A computer system 900 may also include, in an embodiment, one or more communication interfaces 918 coupled to bus 902. A communication interface 918 provides a data communication coupling, typically two-way, to a network link 920 that is connected to a local network 922. For example, a communication interface 918 may be an integrated services digital network (ISDN) card, cable modem, satellite modem, or a modem to provide a data communication connection to a corresponding type of telephone line. As another example, the one or more communication interfaces 918 may include a local area network (LAN) card to provide a data communication connection to a compatible LAN. As yet another example, the one or more communication interfaces 918 may include a wireless network interface controller, such as a 802.11-based controller, Bluetooth controller, Long Term Evolution (LTE) modem, and/or other types of wireless interfaces. In any such implementation, communication interface 918 sends and receives electrical, electromagnetic, or optical signals that carry digital data streams representing various types of information.

Network link 920 typically provides data communication through one or more networks to other data devices. For example, network link 920 may provide a connection through local network 922 to a host computer 924 or to data equipment operated by a Service Provider 926. Service Provider 926, which may for example be an Internet Service Provider (ISP), in turn provides data communication services through a wide area network, such as the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

In an embodiment, computer system 900 can send messages and receive data, including program code and/or other types of instructions, through the network(s), network link 920, and communication interface 918. In the Internet example, a server 930 might transmit a requested code for an application program through Internet 928, ISP 926, local network 922 and communication interface 918. The received code may be executed by processor 904 as it is received, and/or stored in storage device 910, or other non-volatile storage for later execution. As another example, information received via a network link 920 may be interpreted and/or processed by a software component of the computer system 900, such as a web browser, application, or server, which in turn issues instructions based thereon to a processor 904, possibly via an operating system and/or other intermediate layers of software components.

In an embodiment, some or all of the systems described herein may be or comprise server computer systems, including one or more computer systems 900 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 7.0. EXTENSIONS AND ALTERNATIVES

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A system comprising:
one or more user account record access components configured to access user account records, the user account records having assigned subscription states, the subscription states having defined access rules and including at least: an activated state, a deactivated state, and at least one of a grace state or a suspend state;
one or more subscription management components configured to activate and renew subscriptions for the user account records;
one or more state machine components configured to transition the user account records to different assigned subscription states when corresponding state transitions are triggered, at least some of the state transitions being triggered responsive to subscription event messages received from the one or more subscription components;
one or more authorization components configured to authorize client requests using specific access rules, of the access rules, that have been defined for specific subscription states, of the subscription states, that are currently assigned to associated user account records;
one or more external configuration interfaces configured to receive configuration instructions from or in association with external systems;
one or more configuration components configured to, based on a given instruction of the configuration instructions that is received from or in association with a given system of the external systems, configure one or more of: a given state transition to use for user account records that pertain to the given system, or a given access rule to use when user account records that pertain to the given system are in a given state.

2. The system of claim 1, wherein the one or more state machine components are configured to implement different types of state machines for different sets of user account records belonging to different external systems, the different types of state machines including differently-configured state transitions for transitioning between a same plurality of the subscription states.

3. The system of claim 2, wherein at least some of the different types of state machines conform to different state machine templates selected from a set of state machine templates, the set of state machine templates being fewer in number than the different types of state machines.

4. The system of claim 1, wherein based on the access rules the authorization component is configured to, in response to a first client request for a first user account record, authorize access to first content when the first user account record is assigned to the activation state and to the grace state or the suspend state, and not when the first user account record is assigned to the deactivation state.

5. The system of claim 1, wherein a first subscription component of the one or more subscription components is configured to send an initial subscription event message to a first state machine component of the one or more state machine components when activating a new subscription for a user account record, the initial subscription event message triggering a transition to the activated state.

6. The system of claim 1, wherein a first subscription component of the one or more subscription components is configured to send a renewal event message to a first state machine component of the one or more state machine components when renewing a subscription for a user account record, the renewal event message triggering a transition to the activated state.

7. The system of claim 1, wherein a first subscription component of the one or more subscription components is configured to send a renewal failure event message to a first state machine component of the one or more state machine components when an attempt to renew a subscription for a user account record fails, the renewal failure event message triggering a transition to the grace state or the suspend state.

8. The system of claim 1, wherein a timer component of the system is configured to send an event message indicating that a grace period or a suspend period is expired to a first state machine component of the one or more state machine components when an attempt to renew a subscription for a user account record fails, the event message triggering a transition away from the grace state or the suspend state.

9. The system of claim 1, wherein the subscription states include a parking state, wherein a first subscription component of the one or more subscription components is configured to send an initial subscription failure event message to a first state machine component of the one or more state machine components when failing to activate a new subscription for a user account record, the initial subscription failure event message triggering a transition to the parking state, wherein while the user account record has the parking state, at least one of the following is configured to occur occurs: the authorization component authorizes access to first content requested for the user account record; the first subscription component makes one or more additional attempts to activate the new subscription.

10. The system of claim 1, wherein the one or more subscription management components are configured to activate and renew subscriptions for the user account records by at least: sending verification requests to subscription eligibility criteria verification components indicating the subscriptions and/or subscription eligibility criteria to verify, and determining whether to activate or renew the subscriptions based on responses to the verification requests.

11. The system of claim 1, wherein the one or more state machine components are configured to implement different types of state machines for different sets of user account records belonging to different external systems, wherein different access rules apply to a same state depending on which of the different types of state machines is maintaining the state, the different access rules having been configured in response to configuration instructions from the different external systems.

12. The system of claim 1, wherein the one or more state machine components are configured to implement different types of state machines for different sets of user account records belonging to different external systems, wherein different access rules apply to a same state depending on which of the different types of state machines is used.

13. The system of claim 1, wherein the subscription states include a grace state and a suspend state, the grace state being associated with an access rule that grants access to at least a first partial set of content permitted for a given subscription, the suspend state being associated with an access rule that grants access to no more than a second partial set of content permitted for the given subscription, second partial set being smaller than the first partial set.

14. The system of claim 1, wherein a first access rule associated with the grace state or the suspend state permits access to only a lesser-quality version of content permitted for a given subscription.

15. The system of claim 1, wherein the multiple external systems include at least two different network provider systems through which client devices associated with the user account records access content authorized by the one or more authorization components.

16. A system comprising:
one or more user account record access components configured to access user account records;
one or more subscription management components configured to activate and renew subscriptions for the user account records, the subscription management component comprising retry logic configured to, when an activation or renewal of a subscription fails, attempt to activate or renew the subscription one or more additional times, the subscription management component further comprising fallback logic configured to, when an activation or renewal of a given subscription fails, attempt to activate or renew one or more lower-level subscriptions associated with the given subscription;
one or more authorization components configured to authorize client requests using specific access rules associated with the subscriptions;
one or more external configuration interfaces configured to receive configuration instructions from or in association with external systems;
one or more configuration components configured to, based on a given instruction of the configuration instructions that is received from or in association with a given system of the external systems, perform at least one of: configure the retry logic for user account records that pertain to the given system, or configure a fallback subscription plan for user account records that pertain to the given system.

17. The system of claim 16, wherein the multiple external systems include at least two different network provider systems through which client devices associated with the user account records access content authorized by the one or more authorization components.

18. The system of claim 16, wherein the retry logic is configured to schedule the one or more additional times based on a previous history of successful and/or failed activation or renewal attempts.

19. The system of claim 16, wherein the fallback subscription plan specifies, for a first subscription, a set of one or more additional subscriptions to attempt.

20. The system of claim 19, wherein the one or more additional subscriptions are of increasingly shorter terms of time, and/or provide increasingly less quality or quantity of content than the given subscription.
